(19) United States
(12) Patent Application Publication
(10) Pub. No.: US 2025/0019576 A1
(43) Pub. Date: Jan. 16, 2025

(54) FILM COMPRISING AN ETHYLENE-A-OLEFIN COPOLYMER

(71) Applicant: SABIC GLOBAL TECHNOLOGIES B.V., BERGEN OP ZOOM (NL)

(72) Inventors: Li YUAN, Shanghai (CN); Ling FAN, Shanghai (CN); Rajesh CHITTA, Riyadh (SA); Qiang WANG, Shanghai (CN); Shengming CUI, Shanghai (CN); You Jun WU, Shanghai (CN)

(21) Appl. No.: 18/712,754

(22) PCT Filed: Nov. 23, 2022
(86) PCT No.: PCT/EP2022/083001

§ 371 Date: May 23, 2024

(30) Foreign Application Priority Data
Nov. 29, 2021 (WO) PCT/CN2021/133806
Jan. 5, 2022 (EP) 22150315.4

(51) Int. Cl. C09J 7/38; B32B 27/08; B32B 27/32; C09J 7/29

(52) U.S. Cl. CPC C09J 7/381; B32B 27/08; B32B 27/32; B32B 27/327; C09J 7/29; B32B 2250/242; B32B 2307/72; B32B 2307/7376; B32B 2307/748; B32B 2405/00; B32B 2571/00; C09J 2301/414

(57) ABSTRACT

A film includes an ethylene-α-olefin copolymer. The film is a layer in a multilayer structure. The film has improved peel force and leaves no residue after being peeled off from a substrate.

### CROSS REFERENCE TO RELATED APPLICATIONS

This application is a National Stage application of PCT/EP2022/083001, filed Nov. 23, 2022, which claims the benefit of PCT/CN2021/133806, filed Nov. 29, 2021, and European Application 22150315.4, filed Jan. 5, 2022, all of which are incorporated by reference in their entirety herein.

### FIELD

The present invention relates to a film comprising an ethylene-α-olefin copolymer. The film according to the invention is preferably a layer in a multilayer structure. The present invention further relates to the use of the film.

### BACKGROUND

Films comprising an ethylene-α-olefin copolymer are well known in the art and widely used for packaging purposes. The film of the present application is preferably to be used for protecting the surface of an object. The surface requiring such protection is usually prone to scratching damage or contamination, e.g. an LCD display. When a film is used for this purpose, it is often directly stuck to the surface to render protection against scratching, abrasion, contamination, etc without the help of any additional adhesive. For this reason, such film is usually referred to as self-adhesive protective film.

Self-adhesive protective films typically require a delicate balance in terms of adhesive properties: The adhesion should be strong enough so that a certain level of peel force is required to peel the film off the surface and the film cannot be peeled off by accident, whilst there should be no residue of the film remaining on the surface of the object after having been peeled off.

### SUMMARY

It is the object of the present invention to provide a film with sufficient peel force and without any residue after peel. The film according to the invention also has excellent processability.

The object is achieve by a film comprising an ethylene-α-olefin copolymer comprising moieties derived from ethylene and moieties derived from an α-olefin comprising 3 to 10 carbon atoms, wherein the ethylene-α-olefin copolymer has:
a short chain branching ratio (SCBR) of >0.85, preferably of >0.85 and <5.00, wherein SCBR is defined as:

$$SCBR = \frac{{SCB}_{200}}{{SCB}_{20}}$$

wherein SCB₂₀₀ is the quantity of short chain branches (SCB) of the ethylene-α-olefin copolymer at M_{w}=200,000 g/mol and SCB₂₀ is the quantity of short chain branches of the ethylene-α-olefin copolymer at M_{w}=20,000 g/mol, wherein the SCB quantity is determined via GPC-IR and expressed as the number of branches per 1000 carbon atoms (/1000C);
a melt flow rate (MFR) of at least 1.5 g/10 min, preferably in the range from 1.5-20.0 g/10 min as measured according to ASTM D1238-20 at 190° C. with a 2.16 kg load; and
a fraction of material that is eluted in analytical temperature rising elution fractionation (a-TREF) at a temperature ≤30.0° C. of ≥5.0 wt % and ≤20.0 wt %, preferably ≥7.5 wt % and ≤19.0 wt %, more preferably ≥11.5 wt % and ≤18.3 wt % based on the total amount of the ethylene-α-olefin copolymer.

### DETAILED DESCRIPTION

It was surprisingly found by the inventors that the film according to the present invention has excellent processability, enough peel force and has no residue on the surface after being peel off.

### The Ethylene-α-Olefin Copolymer

The ethylene-α-olefin copolymer as used in the film according to the present invention preferably has a density of ≥870 and ≤920 kg/m³, preferably of ≥890 and ≤910 kg/m³, more preferably of >893 and ≤907 kg/m³ as measured according to ASTM D1505-10. A higher density could lead to reduced adhesion and a lower density could lead to poor heat resistance of the film.

The ethylene-α-olefin copolymer preferably demonstrates an elution temperature gap (Peak gap) of ≥5.0 and ≤20.8° C. between its two distinct peaks P1 and P2 in the a-TREF curve in the temperature range of between 50.0 and 90.0° C., also referred to in this application as the peak gap. Preferably, the peak gap is ≥7.0 and ≤18.7° C. A peak gap in the preferred range could lead to an ethylene-α-olefin copolymer with improved adhesion strength.

The elution temperature gap or peak gap is measured using analytical temperature rising elution fractionation, also referred to as a-TREF which may be carried out using a Polymer Char Crystaf-TREF 300 equipped with stainless steel columns having a length of 15 cm and an internal diameter of 7.8 mm, with a solution containing 4 mg/ml of sample prepared in 1,2-dichlorobenzene stabilised with 1 g/l Topanol CA (1,1,3-tri (3-tert-butyl-4-hydroxy-6-methylphenyl) butane) and 1 g/l Irgafos 168 (tri (2,4-di-tert-butylphenyl) phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution may be performed with a heating rate of 1° C./min from 30° C. to 140° C. The set-up may be cleaned at 150° C. The sample injection volume may be 300 μl, and the pump flow rate during elution 0.5 ml/min. The volume between the column and the detector may be 313 μl. The fraction that is eluted at a temperature of ≤30.0° C. may in the context of the present invention be calculated by subtracting the sum of the fraction eluted >30.0° C. from 100%, thus the total of the fraction eluted ≤30.0° C., and the fraction eluted >30.0° C. to add up to 100.0 wt %. In the present invention, the ethylene-α-olefin copolymers has a fraction of material that is eluted in analytical temperature rising elution fractionation (a-TREF) at a temperature ≤30.0° C. of ≥5.0 wt % and ≤20.0 wt %, preferably ≥7.5 wt % and ≤19.0 wt %, more preferably ≥11.5 wt % and ≤18.3 wt % based on the total amount of the ethylene-α-olefin copolymer. It was found the ethylene-α-olefin copolymers having a fraction of material that is eluted at a temperature ≤30.0° C. in the preferred range leads to better adhesion and residue result.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri (3-tert-butyl-4-hydroxy-6-methylphenyl) butane and 1 g/l tri (2,4-di-tert-butylphenyl) phosphite) at a temperature of 150° C. for 1 hour, and further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

In the ethylene-α-olefin copolymer, it is preferred that, by determination of the composition of the ethylene-α-olefin copolymer via a-TREF, the difference Δρ in the density ρ2 of the polymer material that is eluted at peak P2 and the density ρ1 of the polymer material that is eluted at peak P1 (Δρ=ρ2−ρ1) is ≤25 kg/m³, preferably ≥10 and ≤20 kg/m³.

The ethylene-α-olefin copolymer according to the present invention has a melt flow rate, determined at 190° C. under a load of 2.16 kg (MFR), in accordance with ASTM D1238-20, of at least 1.5 g/10 min, preferably in the range from 1.5-20.0 g/10 min, more preferably from 1.9 to 18.0 g/10 min, more preferably from 2.2 to 15.0 g/10 min, even more preferably from 2.5 to 10.0 g/10 min, even more preferably from 2.9 to 4.8 g/min. Such ethylene-α-olefin copolymer allows for manufacturing of films with appropriate melt stability and excellent processability.

The ethylene-α-olefin copolymer comprises moieties derived from ethylene and moieties derived from an α-olefin comprising 3 to 10 carbon atoms. Preferably the amount of moieties derived from the α-olefin is in the range from 15 to 25 wt %, preferably in the range from 18 to 20 wt % based on the total amount of the ethylene-α-olefin copolymer.

The α-olefin comprising 3 to 10 carbon atoms can for example be selected from 1-butene, 1-hexene, 4-methyl-1-pentene, and 1-octene, preferably from 1-butene, 1-hexene and 1-octene. More preferably, the α-olefin is 1-octene. The moieties derived from an α-olefin comprising 3 to 10 carbon atoms may for example be moieties derived from 1-butene, 1-hexene, 4-methyl-1-pentene, 1-octene, and combinations thereof, preferably from 1-octene.

The ethylene-α-olefin copolymer according to the invention has a molecular weight distribution Mw/Mn of >2.0, preferably >2.0 and ≤4.8, wherein Mw is the weight average molecular weight, and Mn is the number average molecular weight, Mw and Mn being determined in accordance with ASTM D6474-20.

In the context of the present invention, the SCB (Short chain branching) quantity is determined via infrared-detection gel permeation chromatography (GPC-IR). GPC-IR analysis may for example be performed using a chromatographer, such as a Polymer Char GPC-IR system, equipped with three columns of internal diameter 7.5 mm and 300 mm length, packed with of particles of 13 μm average particle size, such as Polymer Laboratories 13 μm PLgel Olexis, operating at 160° C., equipped with an MCT IR detector, wherein 1,2,4-trichlorobenzene stabilised with 1 g/l butylhydroxytoluene may be used as eluent at a flow rate of 1 ml/min, with a sample concentration of 0.7 mg/ml and an injection volume of 200 μl, with molar mass being determined based on the universal GPC principle using a calibration made with PE narrow and broad standards in the range of 0.5-2800 kg/mol, Mw/Mn-4 to 15 in combination with known Mark Houwink constants of PE-calibrant alfa=0.725 and log K=−3.721. Short chain branching content was determined via IR determination of the intensity ratio of CH₃ (I_{CH3}) to CH₂ (I_{CH2}) coupled with a calibration curve. The calibration curve is a plot of SCB content (X_{SCB}) as a function of the intensity ratio of I_{CH3}/I_{CH2}. To obtain a calibration curve, a group of polyethylene resins (no less than 5) (SCB Standards) were used. All these SCB standards have known SCB levels and flat SCBD profiles. Using SCB calibration curves thus established, profiles of short chain branching distribution across the molecular weight distribution can be obtained for resins fractionated by the IR5-GPC system under exactly the same chromatographic conditions as for these SCB standards. A relationship between the intensity ratio and the elution volume is converted into SCB distribution as a function of MWD using a predetermined SCB calibration curve (i.e., intensity ratio of I_{CH3}/I_{CH2} vs. SCB content) and MW calibration curve (i.e., molecular weight vs. elution time) to convert the intensity ratio of I_{CH3}/I_{CH2} and the elution time into SCB content and the molecular weight, respectively.

The result of SCB measurement is reported as SCB_{X} which means the quantity of short chain branches per 1000 carbon atoms of the ethylene-α-olefin copolymer at M_{w}=X*1000 g/mol, for instance SCB₂₀₀ refers to the quantity of short chain branches (SCB) of the ethylene-α-olefin copolymer at M_{w}=200,000 g/mol. In the present invention, the ethylene-α-olefin copolymer has a short chain branching ratio (SCBR) of >0.85, preferably of >0.85 and <5.00, more preferably of >0.85 and <2.00, even more preferably of >0.85 and <1.80 wherein SCBR is defined as:

$$SCBR = \frac{{SCB}_{200}}{{SCB}_{20}}$$

wherein SCB₂₀₀ is the quantity of short chain branches (SCB) of the ethylene-α-olefin copolymer at M_{w}=200,000 g/mol and SCB₂₀ is the quantity of short chain branches of the ethylene-α-olefin copolymer at M_{w}=20,000 g/mol, wherein the SCB quantity is determined via GPC-IR and expressed as the number of branches per 1000 carbon atoms (/1000C). It was found that a SCBR in the preferred range leads to an ethylene-α-olefin copolymer with improved adhesion strength.

The ethylene-α-olefin copolymer may for example be produced via a solution polymerisation process, preferably by polymerisation of ethylene with 1-octene. The ethylene-α-olefin is preferably produced using a single site catalyst, preferably a constrained geometry complex (CGC) catalyst.

Preferably, the fraction of the ethylene-α-olefin copolymer in the film is at least 50 wt %, preferably at least 70 wt %, preferably at least 90 wt % based on the total weight of the film. A too low fraction of the ethylene-α-olefin copolymer could lead to reduced adhesion.

The film in the context of the present invention can be a single layer film that can be used individually or as an adhesive layer in a multilayer structure. The multilayer structure can for example be a multilayer film obtained from co-extrusion process or a multilayer laminate obtained by extruding different layers of films then laminating the layers into a laminate.

The thickness of the single layer film or of the adhesive layer in a multilayer structure is preferably in the range from 3 to 100 μm, more preferably in the range from 5 to 20 μm. A too low thickness of the film or of the adhesive layer in a multilayer structure could be difficult to process and lead to variation in thickness and insufficient adhesion; a too high thickness could lead to poor homogeneity of the film thickness.

In an embodiment, the invention relates to a multilayer film comprising a core layer B, a first outer layer A and a second outer layer C, the layers being ordered A/B/C, wherein the layer C is the adhesive layer comprising the films of the invnetion, and each of the layers A and B are layers comprising or consisting of a low-density polyethylene (LDPE).

Preferably, the LDPE has a density of >900 and <935 kg/m³, as measured according to ASTM D1505-10 and/or a melt mass-flow rate of ≥0.1 and ≤10.0 g/10 min, as determined in accordance with ASTM D1238-20 at 190° C. with a 2.16 kg load.

Preferably, the LDPE has a density of preferably >910 and <930 kg/m³, more preferably >915 and <925 kg/m³. Preferably, the LDPE has a melt mass-flow rate of ≥0.5 and ≤10.0 g/10 min, more preferably ≥1.0 and $8.0 g/10 min, even more preferably ≥2.0 and ≤6.0 g/10 min, as determined in accordance with ASTM D1238-20 at 190° C. with a 2.16 kg load.

The LDPE may for example be a polyethylene produced via free-radical polymerisation of a reaction mixture comprising ethylene, preferably wherein the reaction mixture consists of ethylene as sole reactant. For example, the low-density polyethylene may be a homopolymer. The low-density polyethylene may be produced using a high-pressure polymerisation process, such as using a high-pressure tubular polymerisation process or using a high-pressure autoclave polymerisation process, preferably wherein the pressure in the polymerisation reactor is >150 MPa, such as >150 and <300 MPa, more preferably >200 and <300 MPa.

When the film is an adhesive layer in a multilayer structure, the multilayer structure preferably has a thickness in the range from 30 to 200 μm, preferably from 35 to 100 μm, preferably from 40 to 60 μm. Preferably the fraction of the adhesive layer is in the range from 3 to 29 wt %, preferably in the range from 8 to 23 wt % based on the total weight of the multilayer structure. The fraction of the adhesive layer can be calculated using the density and thickness of the layers in the multilayer structure. A multilayer structure comprising an adhesive layer in the preferred range has better mechanical strength since other layers could provide more mechanical support to the multilayer structure.

The multilayer structure may comprise 3 to 7 layers, preferably the multilayer structure comprises three layers, wherein the layers other than the adhesive layer in the multilayer structure could comprise polypropylene and/or polyethylene. Generally, a film or a layer in a multilayer structure comprising mainly polypropylene presents a higher stiffness than that comprising a polyethylene. In the present invention, it is preferred that the other layers comprise a polyethylene, preferably a polyethylene having a density in the range from 912 to 939 kg/m³, preferably in the range from 916 to 927 kg/m³ as measured according to ASTM D1505-10. It is found the preferred polyethylene has improved compatibility with the ethylene-α-olefin copolymer according to the invention in a multilayer structure.

The present invention also relates to the use of a film according to the invention as an adhesive layer of a multilayer structure for improving adhesion strength and/or for reducing residue deposit after peeling from a substrate. The invention also relates to the use of the film according to the invention for improving adhesion strength and/or reducing residue deposit after peeling film from a substrate.

The present invention also relates to an article comprising a surface protected by the film according the invention, preferable the protected surface is a surface for displaying information on an electronic device.

The film according to the invention can be prepared in a conventional process, for example by extrusion blowing or extrusion casting. Such process may for example comprising the following steps:
Providing the ethylene-α-olefin copolymer according to the invention;
Extrusion blowing or extrusion casting the ethylene-α-olefin copolymer according the invention into a film.

In the present invention, both adhesion strength and peel force are indicator of the quality of film's adhesion on the object that the film is rendering protection to. The adhesion strength and peel force are quantified by peel adhesion value measured in accordance to ASTM D3330-2018. A peel adhesion value of at least 2 gf/25 mm is needed for the purpose of the present invention. The substrate employed in the measurement is a polished PMMA plate with a width of 70 mm, a length of 200 mm and a thickness of 2 mm.

### Working Embodiments

Two multilayer structures are prepared using co-extrusion casting. Both structures comprise three layers, the first layer and the second layer consist of SABIC LDPE HP4024N. The third layer is an adhesive layer consisting of ethylene-α-olefin copolymers according to the invention. In both working embodiments, the ethylene-α-olefin copolymers are ethylene-octene copolymer. The thickness of the multilayer structures is 50 μm, the layer thickness ratio of the first, the second and the third layer is 4:4:2. The characteristic of the ethylene-α-olefin copolymers and the properties of the multilayer structures are shown in Table 1.

TABLE 1

| | | Working | Working |
|---|---|---|---|
| | | embodiment 1 | embodiment 2 |
| Properties of the | SCB 20 | 20.89 | 23.98 |
| ethylene-α-olefin | SCB 100 | 28.93 | 22.88 |
| copolymer used | SCB 200 | 31.53 | 23.94 |
| as the third layer | Ratio SCB 200/20 | 1.51 | 1.00 |
| in the multilayer | MFR (g/10 min) | 3.4 | 3.5 |
| structure | Density (kg/m3) | 900 | 902 |
| | Mw/Mn | 4.2 | 2.4 |
| | Peak gap (° C.) | 16.4 | 17.7 |
| | Soluble (wt %) | 17 | 13.7 |
| | C8 (wt %) | 19.2 | 18.1 |
| Properties of the | Peel force | 2.2 | 2.3 |
| multilayer | (gf/25 mm) | | |
| structure | Residue | No | No |

### Measurement Methods:

SCB is determined via infrared-detection gel permeation chromatography (GPC-IR);
MFR is determined according to ASTM D1238-20 at 190° C. with a 2.16 kg load;
Density is determined according to ASTM D1505-10.;
Mw, Mn are determined in accordance with ASTM D6474-20;
Peak gap is the elution temperature gap between two distinct peaks in the a-TREF curve in the elution temperature range of between 50.0 and 90.0° C.;
Soluble is the fraction of material (ethylene-α-olefin copolymers) that is eluted in analytical temperature rising elution fractionation (a-TREF) at a temperature≤30.0° C.;
C8 wt % is the amount of moieties derived from octene in the ethylene-α-olefin copolymers;
Peel force is the peel adhesion value measured in accordance to ASTM D3330-2018.
The substrate employed in the measurement is a polished PMMA plate with a width of 70 mm, a length of 200 mm and a thickness of 2 mm;
Residue after peeling is determined according to a protocol with the following steps:
   Providing a PMMA plate having dimensions of 70*200*2 mm whose surfaces are polished and cleaned;
   Laminating the multilayer structures of a working embodiment on the two largest surfaces of the PMMA plate using low speed setting on DOCON—Hot Roller Laminator (380) at room temperature, wherein the adhesive layers of the multilayer structures are in contact with the PMMA plate;
   Placing the laminated PMMA plate on a flat surface (covered by Teflon film) in an oven set at 50° C., wherein a multilayer structure laminated on the PMMA plate is in contact with the Teflon film. The Teflon film has a larger area than the laminated surface of the PMMA plate;
   Placing a 5 kg load on the laminated PMMA plate. The load is positioned on the other multilayer structure laminated on the PMMA plate. The load has a larger surface than the laminated surface and the load's surface covers all the area of the laminated surface so that the load is evenly distributed on the laminated surface;
   Aging the configuration in the oven for 168 hrs;
   Taking the load and the laminated PMMA plate from the oven and lifting the load from the laminated PMMA plate;
   After cooling down the laminated PMMA plate to 23° C., peeling the both multilayer structures off the PMMA plate in an orthogonal direction from a corner of a laminated surface;
   Repeating the previous step on the other laminated surface of the PMMA plate;
   Observing the peeled PMMA plate under a RAY-BOW A200 GT hand torch in a dark room with naked eyes, wherein the distance between the light source in the hand torch and the plate is kept at 20 cm.

If any residue can be observed on the PMMA plate, the multilayer structure fails the residue measurement for the purpose of the present invention.

Clearly both working embodiments comprising the ethylene-α-olefin copolymers according to the invention show satisfying peel force and residue result.

### Examples

COHERE™ 8402 is an ethylene-octene copolymer commercially available and procured from SABIC Europe B.V. in November 2021. The multilayer structure in IE was prepared using co-extrusion casting. The multilayer structure comprised three layers, the first layer and the second layer consisted of SABIC LDPE HP4024N having a density of 923 kg/m³. The third layer was an adhesive layer consisting of COHERE™ 8402. The thickness of the multilayer structure was 50 μm, the layer thickness ratio of the first, the second and the third layer was 4:4:2, the weigh fraction of the adhesive layer is therefore 20.0 wt % in the multilayer structure. The characteristics of COHERE™ 8402 and the multilayer structure prepared using COHERE™ 8402 are shown in Table 2.

The multilayer structures of CE1-5 were prepared in the same way as IE except that COHERE™ 8402 was substituted by other ethylene-octene copolymers. The properties of these other ethylene-octene copolymers and multilayer structures using these other ethylene-octene copolymers are shown in Table 2.

The same measurement methods used in working embodiments were used to measure the properties in Table 2.

TABLE 2

| | | IE | CE1 | CE2 | CE3 | CE4 | CE5 |
|---|---|---|---|---|---|---|---|
| Properties of the | SCB 20 | 24.82 | 22.62 | 17.26 | 23.1 | 25.33 | 26.37 |
| ethylene-α-olefin | SCB 100 | 23.2 | 23.48 | 18.62 | 23.01 | 23.69 | 21.93 |
| copolymer used | SCB 200 | 23.42 | 24.43 | 20.67 | 22.81 | 24.32 | 20.28 |
| as the third layer | Ratio SCB 200/20 | 0.94 | 1.08 | 1.20 | 0.99 | 0.96 | 0.77 |
| in the multilayer | MFI (g/10 min) | 3.3 | 1.1 | 1 | 3.2 | 3.5 | 3.8 |
| structure | Density (kg/m³) | 900 | 900 | 906 | 899 | 901 | 900 |
| | Mw/Mn | 2.4 | 3.4 | 3 | 2.3 | 2.5 | 2.5 |
| | Soluble (wt %) | 14.9 | 4.9 | 2.6 | 4.1 | 21.4 | 16.8 |
| Properties of the | Peel force | 2.1 | 2.2 | 2.4 | 1.6 | 1.9 | 2.3 |
| multilayer | (gf/25 mm) | | | | | | |
| structure | Residue | No | No | No | No | Yes | Yes |

According to Table 2, only the multilayer structure in IE comprising the ethylene-octene copolymer according to the invention has shown sufficient peel force and does not deposit any residue.

1. A film comprising an ethylene-α-olefin copolymer comprising moieties derived from ethylene and moieties derived from an α-olefin comprising 3 to 10 carbon atoms, wherein the ethylene-α-olefin copolymer has:
a short chain branching ratio (SCBR) of >0.85,
wherein SCBR is defined as:
$$SCBR = \frac{{SCB}_{200}}{{SCB}_{20}}$$
wherein SCB₂₀₀ is the quantity of short chain branches (SCB) of the ethylene-α-olefin copolymer at M_{w}=200,000 g/mol and SCB₂₀ is the quantity of short chain branches of the ethylene-α-olefin copolymer at M_{w}=20,000 g/mol, wherein the SCB quantity is determined via GPC-IR and expressed as the number of branches per 1000 carbon atoms (/1000C);
a melt flow rate (MFR) of at least 1.5 g/10 min, as measured according to ASTM D1238-20 at 190° C. with a 2.16 kg load; and
a fraction of material that is eluted in analytical temperature rising elution fractionation (a-TREF) at a temperature ≤30.0° C. of ≥5.0 wt % and ≤20.0 wt %, based on the total amount of the ethylene-α-olefin copolymer.

2. The film according to claim 1, wherein the ethylene-α-olefin copolymer has:
an MFR of in the range from 1.9 to 18.0 g/10 min, as measured according to ASTM D1238-20 at 190° C. with a 2.16 kg load; and/or
a molecular weight distribution Mw/Mn of ≥2.0, wherein Mw is the weight average molecular weight, and Mn is the number average molecular weight, Mw and Mn being determined in accordance with ASTM D6474-20; and/or
a density of ≥870 and ≤920 kg/m³, as measured according to ASTM D1505-10.

3. The film according to claim 1, wherein the amount of the moieties derived from the α-olefin is in the range from 15 to 25 wt %, based on the total amount of the ethylene-α-olefin copolymer.

4. The film according to claim 1, wherein the ethylene-α-olefin copolymer has two distinct peaks in the a-TREF curve in the elution temperature range of between 50.0 and 90.0° C., wherein the elution temperature gap between the two peaks is ≥5.0 and ≤20.8° C.

5. The film according to claim 1, wherein the ethylene-α-olefin copolymer is polymerized in the presence of a single site catalyst.

6. The film according to claim 1, wherein the amount of the ethylene-α-olefin copolymer is at least 50 wt %, based on the total amount of the film.

7. The film according to claim 1, wherein the film is a single layer film or an adhesive layer in a multilayer structure.

8. A multilayer film comprising a core layer B, a first outer layer A and a second outer layer C, the layers being ordered A/B/C, wherein the layer C is the adhesive layer comprising the films of claim 1, and each of the layers A and B is a layer comprising a low-density polyethylene (LDPE).

9. The film according to claim 8, wherein the LDPE has
a density of >900 and <935 kg/m³, as measured according to ASTM D1505-10; and/or
a melt mass-flow rate of ≥0.1 and ≤10.0 g/10 min, as determined in accordance with ASTM D1238-20 at 190° C. with a 2.16 kg load.

10. The film according to claim 8, wherein the LDPE is a polyethylene produced via free-radical polymerisation of a reaction mixture comprising ethylene.

11. The film according to claim 7, wherein the multilayer structure has a thickness in the range from 30 to 200 μm, and wherein the layers other than the adhesive layer in the multilayer structure comprise polypropylene and/or polyethylene.

12. The film according to claim 7, wherein the fraction of the adhesive layer is in the range from 3 to 29 wt %, based on the total weight of the multilayer structure.

13. A process for the preparation of a film according to claim 1, comprising the following steps:
providing the ethylene-α-olefin copolymer; and
extrusion blowing or extrusion casting the ethylene-α-olefin copolymer into a film.

14. An article comprising a surface protected by the film according to claim 1.

15. (canceled)

16. The film according to claim 1, wherein the α-olefin is 1-butene, 1-hexene or 1-octene.

17. The film according to claim 1, wherein the α-olefin is 1-octene.

18. The film according to claim 1, wherein the amount of the ethylene-α-olefin copolymer is at least 70 wt %, based on the total amount of the film.

19. The film according to claim 7, wherein the thickness of the single layer film or of the adhesive layer in a multilayer structure is in the range from 3 to 100 μm.
